(19) United States
(12) Patent Application Publication
(10) Pub. No.: US 2009/0057064 A1
(43) Pub. Date: Mar. 5, 2009

(54) Oil pan structure and internal combustion engine

(76) Inventor: Akihiro Ikeda, Nagoya-shi (JP)

Correspondence Address: KENYON & KENYON LLP, 1500 K STREET N.W., SUITE 700, WASHINGTON, DC, 20005, US

(21) Appl. No.: 12/230,370

(22) Filed: Aug. 28, 2008

(30) Foreign Application Priority Data
Aug. 29, 2007 (JP) 2007-222866

(51) Int. Cl. F16N 31/00

(52) U.S. Cl. 184/106

(57) ABSTRACT

An oil pan structure for an internal combustion engine includes: a small-depth portion having a bottom that is positioned at a high level; a large-depth portion formed adjacent to the small-depth portion and having a bottom that is positioned at a lower level than that of the small-depth portion, said large-depth portion defining an interior space in which an oil suction member is housed; and a ridge portion that connects a vertical wall that forms the large-depth portion with a bottom wall that forms the small-depth portion. The ridge portion includes a first connecting portion that connects the vertical wall of the large-depth portion with the bottom wall of the small-depth portion via a curved surface, and a second connecting portion that connects the vertical wall of the large-depth portion with the bottom wall of the small-depth portion at a position lower than that of the first connecting portion.

### INCORPORATION BY REFERENCE

The disclosure of Japanese Patent Application No. 2007-222866 filed on Aug. 29, 2007, including the specification, drawings and abstract, is incorporated herein by reference in its entirety.

### BACKGROUND OF THE INVENTION

1. Field of the Invention

This invention relates to a structure of an oil pan provided in an internal combustion engine, such as an engine for an automobile, and an internal combustion engine including the oil pan. In particular, the invention relates to an improvement in the shape of the oil pan having a small-depth portion and a large-depth portion.

2. Description of the Related Art

In an engine for an automobile, or the like, engine oil (which will be simply called “oil”) is stored in an oil pan that is provided in a lower part of the cylinder block. When an oil pump is driven using the torque of the crankshaft, the oil in the oil pan is drawn up via a strainer, and is fed under pressure to various parts of the engine, for lubrication or cooling of these parts. The oil that has been used for lubrication or cooling of the engine parts drops into the interior of the oil pan, to be collected for reuse (as disclosed in, for example, Japanese Patent Application Publication No. 2003-49624 (JP-A-2003-49624)). The oil pump may be of a motor-driven or electrically-operated type.

When the automobile runs on an inclined road or slope, or when a lateral acceleration (centrifugal force) is applied to the automobile during cornering, the oil stored in the oil pan may shift to one side and accumulate on this side in the oil pan. In this case, the oil pump may be brought into a condition (which will be called “air sucking condition”) in which an oil inlet of the above-mentioned strainer is exposed to the air. In the air sucking condition, lubricating oil fails to be introduced into the oil pump (i.e., the oil pump is brought into a “dry” state), and the operation to circulate the oil is not smoothly performed. Furthermore, various sliding parts in a pumping mechanism of the oil pump suffer from poor lubrication, resulting in wear of components that constitute the pump, and its sealed regions may not provide desired air- or oil-tightness, resulting in reduction in the reliability of the pump.

Technologies for avoiding the “air sucking condition” as described above have been proposed in Japanese Patent Application Publication No. 8-189324 (JP-A-8-189324) and Japanese Patent Application Publication No. 6-101568 (JP-A-6-101568). In the structures as disclosed in these publications, the bottom of the oil pan is shaped so as to provide a small-depth portion and a large-depth portion, and an oil strainer is placed in the large-depth portion that permits the oil to be stored to a large depth, so as to avoid the “air sucking condition” as described above. In an engine having a relatively large displacement, which is installed on, for example, a SUV (Sport Utility Vehicle), a large-sized oil pan is employed in which a large amount of oil is to be stored, and the depth of the large-depth portion is also set to a relatively large value.

In the structure as disclosed in JP-A-8-189324, vertical ribs extending in the vertical direction and a top-face rib that spreads in the horizontal direction at the upper ends of the vertical ribs are provided on an outer circumferential surface of a suction member located in the large-depth portion, so that air is inhibited from flowing into an oil inlet of the suction member.

In the structure as disclosed in JP-A-6-101568, a structural component, which is to be immersed under an oil surface when the oil surface is inclined during, for example, cornering of the automobile, is bolted to the cylinder block via a support or supports. With this arrangement, the “air sucking condition” may be avoided by raising the oil level by an amount corresponding to the volume of the structural component when the oil surface is inclined.

However, the above-described structures of JP-A-8-189324 and JP-A-6-101568 have problems as described below.

In the structure of JP-A-8-189324, since the vertical ribs and top-face rib need to be provided on the outer circumferential surface of the suction member, the structure of the suction member and the production thereof tend to be complicated. Also, the outer edges or peripheries of the vertical ribs and top-face rib need to be located close to the inner wall of the large-depth portion of the oil pan, so that the vertical ribs and top-face rib effectively restrict or inhibit flowing of air into the suction member. Thus, it takes substantial time and effort to design the shapes of the outer edges of the vertical ribs and top-face rib and the shape of the inner wall of the large-depth portion, with a low degree of flexibility or freedom in design thereof, resulting in a significant restriction imposed on the shape of the oil pan. Thus, the oil pan having this structure is not suitable for practical use.

In the structure of JP-A-6-101568, the structural component needs to be bolted to the cylinder block via the support(s), resulting in an increase in the number of components and complication of the assembling procedure. Thus, the oil pan having this structure is not suitable for practical use, as in the case of JP-A-8-189324.

The above-described technologies as disclosed in JP-A-8-189324 and JP-A-6-10156 aim to avoid the “air sucking condition” under a situation where a certain amount of oil is stored in the large-depth portion of the oil pan. Namely, the technologies of these publications are based on a technical concept that it is possible to avoid the “air sucking condition” by keeping the level of the oil stored in the large-depth portion at a sufficiently high level even when the oil pan is in an inclined state. Thus, if the amount of oil collected into the large-depth portion is kept extremely reduced for a relatively long period of time, as compared with the amount of oil drawn up by the oil pump through the strainer, namely, if the amount of oil collected into the large-depth portion after being circulated through various engine parts is kept extremely reduced for a relatively long period of time, the structures of the above publications may not be expected to provide the effect of avoiding the air sucking condition. In the following description, this situation will be explained more specifically.

FIG. 8 is a view showing an oil pan o including a small-depth portion b and a large-depth portion c, in which the small-depth portion b is located on the front side of the vehicle and the large-depth portion c is located on the rear side of the vehicle. Referring to FIG. 8, the oil storage condition and oil collecting condition of the oil pan o when the vehicle runs on a downhill will be explained.

While the vehicle keeps running on a downhill, the oil in the large-depth portion c is drawn up via a strainer d in accordance with driving of the oil pump. Then, the oil is collected into the oil pan o for reuse after being circulated along the inner walls of the cylinder block and the outer surface of the crankshaft. In this case, the oil flows down, along the inner walls of the cylinder block and the outer surface of the crankshaft, toward the front side of the vehicle body due to its own weight. Therefore, a large portion of the oil collected in the oil pan o reaches the small-depth portion b. The length of arrows shown in FIG. 8 represents the amount of the oil that drops or flows down into each region of the oil pan o. Namely, a large amount of oil is collected in a region of the oil pan where the arrow has a large length, and a small amount of oil is collected in a region where the arrow has a small length. In FIG. 8, virtual lines (two-dot chain lines) indicate the respective oil levels in the large-depth portion c and small-depth portion b at the time when the vehicle starts running on the downhill, and solid lines indicate the respective oil levels in the large-depth portion c and small-depth portion b at the time when the vehicle has run on the downhill for a certain period of time. While the oil in the large-depth portion c is drawn up and the oil level in this portion c is lowered, as indicated by the solid line, a large portion of the oil collected into the oil pan o reaches the small-depth portion b without flowing into the large-depth portion c.

In the oil collecting condition as described above, a sufficient amount of oil may not be collected into the large-depth portion c unless the oil level of the oil collected into the small-depth portion b is elevated to be higher than the top edge of a ridge portion e between the small-depth portion b and the large-depth portion c (i.e., unless the oil overflows from the top edge of the ridge portion e into the large-depth portion c).

In the above-described case, while a sufficient amount of oil is collected in the oil pan o as a whole, a large portion of the oil collected is present in the small-depth portion b, and the amount of the oil stored in the large-depth portion c is extremely reduced, with the oil level being largely lowered, which may result in the “air sucking condition” as described above. This situation cannot be avoided through the use of the structures as disclosed in JP-A-8-189324 and JP-A-6-101568, and there still remains a concern about the occurrence of the air sucking condition.

In an engine having a relatively large displacement, which is installed on a vehicle, such as SU, in particular, a large-sized oil pan is employed, and its small-depth portion has a relatively large volume. Therefore, unless a large amount of oil is collected into the oil pan as a whole, the oil is unlikely to flow over the top edge of the ridge portion, from the small-depth portion into the large-depth portion, (i.e., the oil level is unlikely to be elevated to be higher than the top edge of the ridge portion). In a condition where a large amount of oil is collected in the small-depth portion, the oil level has already been largely lowered in the large-depth portion, which creates a high possibility of the occurrence of the air sucking condition.

### SUMMARY OF THE INVENTION

It is an object of the invention to provide an oil pan structure for an oil pan including a small-depth portion and a large-depth portion, which ensures a sufficiently large amount of oil collected in the large-depth portion even in a situation where the oil pan is kept in an inclined state, so as to avoid the “air sucking condition”. It is another object of the invention to provide an internal combustion engine including the oil pan.

In an oil pan according to one aspect of the invention, the ridge portion includes a relatively low-level region that permits flowing of oil from the small-depth portion into the large-depth portion even in a situation where the oil level in the small-depth portion is relatively low, when the oil pan is in an inclined state in which the small-depth portion is shifted downward. With the low-level region provided in a part of the ridge portion, a sufficiently large amount of oil can be collected in the large-depth portion even when the oil pan is kept in the inclined state.

More specifically, an oil pan according to a first aspect of the invention is provided in a lower part of an internal combustion engine, and includes a small-depth portion having a bottom that is positioned at a high level, a large-depth portion formed adjacent to the small-depth portion and having a bottom that is positioned at a lower level than that of the small-depth portion, the large-depth portion defining an interior space in which an oil suction member is housed, and a ridge portion that connects a vertical wall that forms the large-depth portion with a bottom wall that forms the small-depth portion. In this oil pan, the ridge portion includes a first connecting portion that connects the vertical wall of the large-depth portion with the bottom wall of the small-depth portion via a curved surface, and a second connecting portion that connects the vertical wall of the large-depth portion with the bottom wall of the small-depth portion at a position lower than that of the first connecting portion.

An oil pan according to a second aspect of the invention is provided in a lower part of an internal combustion engine, and includes a small-depth portion having a bottom that is positioned at a high level, a large-depth portion formed adjacent to the small-depth portion and having a bottom that is positioned at a lower level than that of the small-depth portion, the large-depth portion defining an interior space in which an oil suction member is housed, and a ridge portion that connects a vertical wall that forms the large-depth portion with a bottom wall that forms the small-depth portion. In this oil pan, the ridge portion includes a first connecting portion and a second connecting portion. The first connecting portion connects an upper end of the vertical wall of the large-depth portion continuously with a distal end of the bottom wall of the small-depth portion, in a region in which the upper end of the vertical wall of the large-depth portion has a vertical position that is substantially equal to that of the bottom wall of the small-depth portion, and the distal end of the bottom wall of the small-depth portion lies at a position up to which the vertical wall of the large-depth portion rises. On the other hand, the second connecting portion connects the upper end of the vertical wall of the large-depth portion with the distal end of the bottom wall of the small-depth portion at a position lower than the first connecting portion, in a region in which the upper end of the vertical wall of the large-depth portion has a vertical position that is lower than that of the bottom wall of the small-depth portion, and the distal end of the bottom wall of the small-depth portion lies at a position that is retracted from a position up to which the vertical wall of the large-depth portion rises.

With the above arrangements, when the oil pan is not in an inclined state, such as when the vehicle is running on a flat road, a large portion of the oil in the oil pan is stored in the large-depth portion, and the oil that has been used for lubrication and cooling of various parts of the engine is collected into the large-depth portion and small-depth portion. Furthermore, the oil that has been collected in the small-depth portion quickly flows into the large-depth portion, thereby to ensure a sufficiently high level of the oil in the large-depth portion. Consequently, no “air sucking condition” occurs, namely, an oil inlet of an oil suction member (such as an oil strainer) is prevented from being exposed to the air.

When the oil pan is brought into an inclined state in which the small-depth portion is shifted downward, such as when the vehicle is running on a hill, a large portion of the oil that has been used for lubrication and cooling of various parts of the engine is collected into the small-depth portion due to its own weight. In the oil pan structure according to the first or second aspect of the invention, in which the second connecting portion that connects the vertical wall of the large-depth portion with the bottom wall of the small-depth portion at a relatively low position or level is provided in a portion of the ridge portion between the small-depth portion and the large-depth portion, the oil level in the small-depth portion easily goes beyond (i.e., becomes higher than) the second connecting portion, and the oil flow into the large-depth portion via the second connection portion, even in a situation where the oil level in the small-depth portion is relatively low, namely, where the amount of oil collected into the small-depth portion is relatively small. Thus, even when the oil pan is in the inclined state, the level of the oil in the large-depth portion is kept sufficiently high, and the occurrence of the “air sucking condition” in which the oil inlet of the oil suction member is exposed to the air is avoided.

Since the above-described effects are provided only by improving the shape of the oil pan, the freedom or flexibility in design of the oil pan is not reduced under influences of other components. Furthermore, the first connecting portion and the second connecting portion are formed as integral parts on the oil pan, thus making it possible to provide an oil pan with high practicality, without increasing the number of components of the oil pan or complicating the process of assembling the components into the oil pan.

The second connecting portion is provided only in a part of the ridge portion between the small-depth portion and the large-depth portion, and the remaining part of the ridge portion, i.e., the first connecting portion, formed with a curved surface having a certain radius of curvature connects the large-depth portion with the small-depth portion at a relatively high level or vertical position. Therefore, when the oil pan is not in an inclined state, flowing of the oil from the large-depth portion into the small-depth portion is effectively restricted or inhibited at a location where the first connecting portion is formed, and the first connecting portion contributes to establishment of a sufficiently high oil level in the large-depth portion.

According to the first or second aspect of the invention, the ridge portion as a boundary between the small-depth portion and large-depth portion of the oil pan includes, as a portion thereof, a relatively low-level region that permits flowing of the oil from the small-depth portion into the large-depth portion even in a situation where the oil pan is in an inclined state and the oil level in the small-depth portion is relatively low. Thus, even if the oil pan is kept in the inclined state, a sufficient amount of oil is surely collected in the large-depth portion, and the “air sucking condition” in which the oil inlet of the strainer is exposed to the air can be effectively avoided.

An internal combustion engine according to a third aspect of the invention includes an oil pan having the oil pan structure according to the first or second aspect of the invention.

In the internal combustion engine according to the third aspect of the invention, a sufficient amount of oil is surely collected in the large-depth portion even if the engine is kept in an inclined position, and the “air sucking condition” in which the oil inlet of the strainer is exposed to the air can be effectively avoided.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a perspective view of an oil pan according to one embodiment of the invention;

FIG. 2 is an exploded perspective view of the oil pan;

FIG. 3A and FIG. 3B are cross-sectional views showing a condition in which an upper oil pan, a lower oil pan and an oil strainer are assembled together, wherein FIG. 3A is a cross-sectional view taken along line 3A-3A in FIG. 1, and FIG. 3B is a cross-sectional-view taken along line 3B-3B in FIG. 1;

FIG. 4A is a view showing an automobile running on a flat road, and FIG. 4B is a cross-sectional view showing an oil storage condition in the oil pan during flat-road running of the automobile;

FIG. 5A is a view showing an automobile running on a downhill, and FIG. 5B is a cross-sectional view showing an oil storage condition in the oil pan during downhill running of the automobile;

FIG. 6 is a view corresponding to that of FIG. 3B, which shows an oil pan according to a modified example of the embodiment of FIG. 1;

FIG. 7 is a perspective view of an oil pan according to another modified example of the embodiment of FIG. 1; and

FIG. 8 is a cross-sectional view showing an oil storage condition in an oil pan of the related art, during downhill running of an automobile.

### DETAILED DESCRIPTION OF EMBODIMENTS

One embodiment of the invention will be described with reference to the drawings. In this embodiment, the invention is applied to an oil pan provided in an engine that is installed on a SUV (Sport Utility Vehicle).

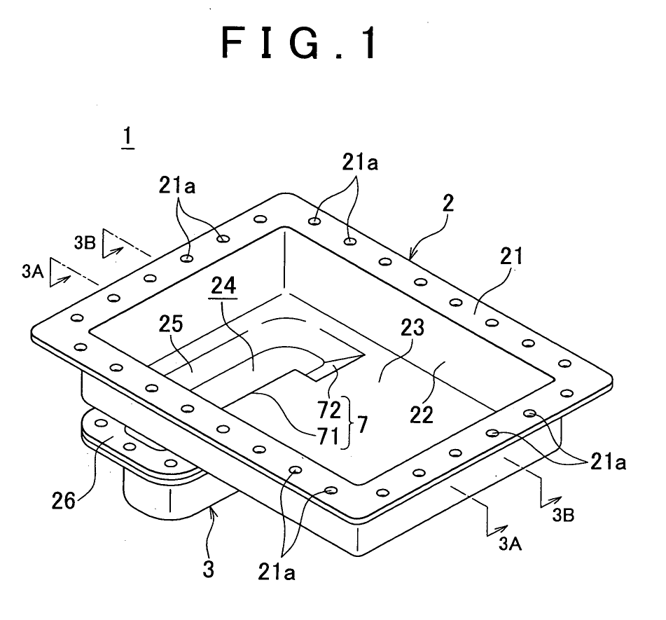

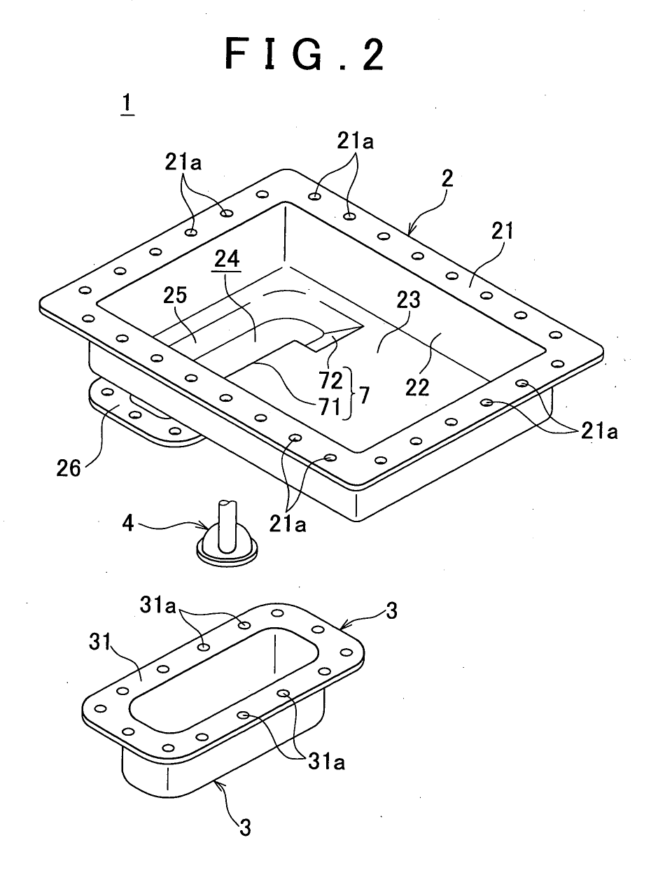

FIG. 1 is a perspective view of the oil pan 1 according to this embodiment of the invention, and FIG. 2 is an exploded perspective view of the oil pan 1. As shown in FIG. 1 and FIG. 2, the oil pan 1 consists of an upper oil pan 2 made of an aluminum alloy, and a lower oil pan 3 made of iron, which are assembled together into an integral structure. For example, the upper oil pan 2 is formed by casting, and the lower oil pan 3 is formed by sheet-metal stamping. It is to be understood that the materials of the upper oil pan 2 and the lower oil pan 3 and the methods of working thereof are not limited to those as described above.

Referring to FIG. 2, an oil strainer 4 through which oil stored in the lower oil pan 3 is drawn up is housed in the lower oil pan 3. The oil strainer 4 is connected to an inlet of an oil pump that is driven with engine power. With this arrangement, as the oil pump is driven, the oil in the lower oil pan 3 is drawn up via the oil strainer 4, to be fed under pressure to various parts of the engine and used for lubrication or cooling of these parts. The oil that has been used for lubrication or cooling of the engine parts drops into the oil pan 1 and is collected in the oil pan 1 for reuse.

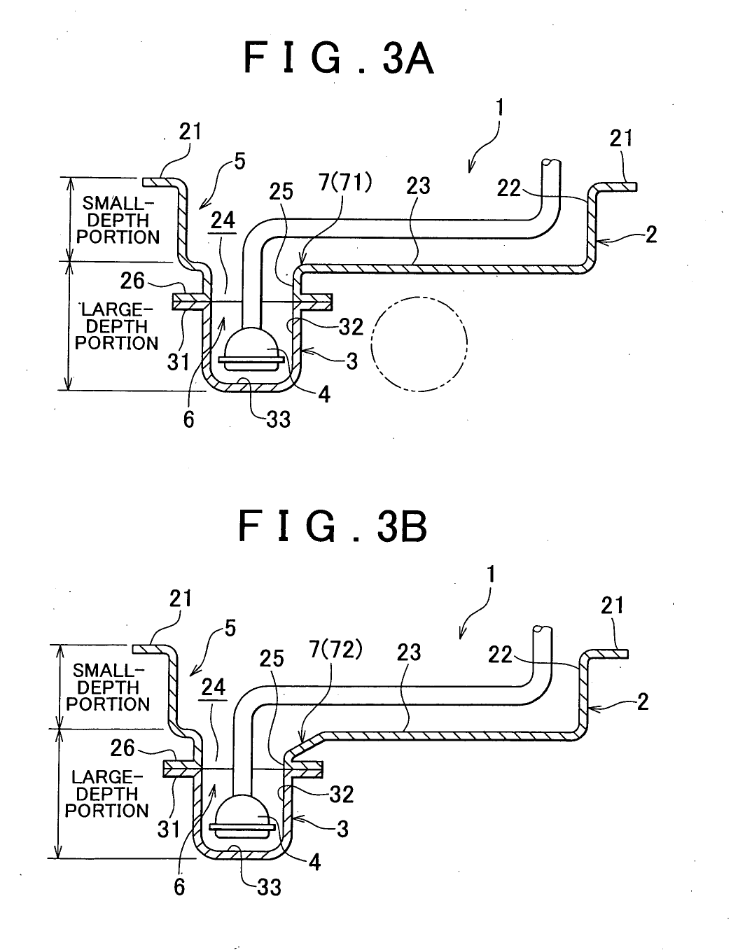

FIG. 3A is a cross-sectional view taken along line 3A-3A in FIG. 1, showing a condition in which the upper oil pan 2, lower oil pan 3 and the oil strainer 4 are assembled together.

As shown in FIG. 3A, the upper oil pan 2 is attached to a lower surface of a cylinder block (not shown), and is formed with a mounting flange 21 that extends over the entire circumference of the top edge thereof at which the upper oil pan 2 is attached to the cylinder block. Also, mounting holes 21a adapted to receive mounting bolts are formed at a plurality of locations of the mounting flange 21, as shown in FIG. 1.

The upper oil pan 2 includes a wall portion 22 that extends from the inner edge of the mounting flange 21 downwards in a generally vertical direction. The vertical position of the lower end of the wall portion 22 is set at substantially the same level over the entire circumference of the upper oil pan 2. The upper oil pan 2 further includes a bottom portion 23 that extends inwards from the lower end of the wall portion 22 in a substantially horizontal direction (i.e., extends in a horizontal direction when the vehicle runs on a flat road and the oil pan 1 is not inclined). The bottom portion 23 may be slightly inclined downwards toward an opening 24 that will be described later.

The opening 24 having a relatively large diameter is formed in a rear portion of the bottom portion 23 of the upper oil pan 2 as viewed in the longitudinal direction of the vehicle, such that the opening 24 extends through the bottom portion 23 in the direction of the thickness (i.e., vertical direction) thereof. As described later, the opening 24 communicates with the interior space of the lower oil pan 3.

The upper oil pan 2 further includes a vertical wall portion 25 formed generally in the shape of a flattened cylinder at the periphery of the opening 24, such that the vertical portion 25 extends continuously from the bottom portion 23. The shape or configuration of a connecting portion that connects the vertical wall portion 25 with the bottom portion 23 will be described in detail later. In addition, a flange 26 to be joined to the top edge of the lower oil pan 3 is formed at the bottom edge of the vertical wall portion 25.

Thus, the upper oil pan 2 is formed as an oil storage container or reservoir having a relatively small depth.

On the other hand, the lower oil pan 3 is joined to the lower end of the vertical wall portion 25 that is formed integrally with the bottom portion 23 of the upper oil pan 2, so as to communicate with the opening 24. More specifically, the shape of the lower oil pan 3 as viewed in a horizontal plane is substantially identical with the shape of the periphery of the opening 24, and a mounting flange 31 to be attached to the upper oil pan 2 is formed over the entire circumference of the top edge of the lower oil pan 3. Also, mounting holes 31a, 31a, . . . adapted to receive mounting bolts are formed at a plurality of locations of the mounting flange 31, as shown in FIG. 2.

The lower oil pan 3 includes a wall portion 32 that extends from the inner edge of the mounting flange 31 downwards in a generally vertical direction. The vertical dimension, or height, of the wall portion 32 is set to be relatively large, so as to increase the volume of the interior of the lower oil pan 3. The lower oil pan 3 further includes a bottom portion 33 that extends inwards from the lower end of the wall portion 32 in a generally horizontal direction (i.e., extends in a horizontal direction when the vehicle runs on a flat road and the oil pan 1 is not inclined).

Thus, the lower oil pan 3 is formed as an oil storage container or reservoir having a relatively large depth. The lower oil pan 3 is located at a rear portion of the bottom portion 23 of the upper oil pan 2 as viewed in the longitudinal direction of the vehicle, so as to avoid interference with a driveshaft that extends below the oil pan 1 in the vehicle-width direction. The virtual line (two-dot chain line) in FIG. 3A indicates the position at which the driveshaft is installed. Thus, the lower oil pan 3 serving as a large-depth oil storage container is provided in a part of the oil pan 1, so as to ensure a large amount of oil stored in the oil pan 1 while avoiding interference of the oil pan 1 with the driveshaft.

As described above, the lower oil pan 3 is joined to the lower end of the upper oil pan 2, to form the oil pan 1. Therefore, the interior space of the oil pan 1 has a small-depth portion 5 having a bottom that is positioned at a relatively high level, and a large-depth portion 6 having a bottom that is positioned at a level lower than that of the small-depth portion 5, as shown in FIGS. 3A and 3B. In this embodiment, the small-depth portion 5 is constituted by the wall portion 22 and bottom portion 23 of the upper oil pan 2, and the large-depth portion 6 is constituted by the vertical wall portion 25 of the upper oil pan 2 and the lower oil pan 3.

The present embodiment is characterized by the shape of a ridge portion 7 as a connecting portion that connects the small-depth portion 5 with the large-depth portion 6, namely, a connecting portion that connects the bottom portion 23 and vertical wall portion 25 of the upper oil pan 2 with each other.

As shown in FIG. 1 and FIG. 2, the ridge portion 7 includes a first connecting portion 71 that extends from one end of the ridge portion 7 as viewed in the longitudinal direction thereof (i.e., the vehicle-width direction in this embodiment) to a middle portion thereof, and a second connecting portion 72 formed only in the other longitudinal end portion of the ridge portion 7. For example, where the ridge portion 7 has a dimension of 500 mm as measured in the longitudinal direction, the longitudinal dimension of its region in which the first connecting portion 71 is formed is 400 mm, and the longitudinal dimension of its region in which the second connecting portion 72 is formed is 100 mm. The dimensions and the ratio of the dimensions are not limited to those of this example.

FIG. 3A is a cross-sectional view taken along line 3A-3A in FIG. 1, as described above, and shows a section of the first connecting portion 71. On the other hand, FIG. 3B is a cross-sectional view taken along line 3B-3B in FIG. 1, and shows a section of the second connecting portion 72.

In the first connecting portion 71 as shown in FIG. 3A, the upper end of the vertical wall portion 25 that constitutes the large-depth portion 6 is located at the same level as that of the bottom portion 23 that constitutes the small-depth portion 5. In a region where the distal end of the bottom portion 23 is located at a position up to which the vertical wall portion 25 rises in the vertical direction, a curved surface having a certain radius of curvature (e.g., a radius of 10 mm) is formed so as to connect the upper end of the vertical wall portion 25 with the distal end of the bottom portion 23.

In the second connecting portion 72, on the other hand, the upper end of the vertical wall portion 25 that constitutes the large-depth portion 6 is located at a level lower than that of the bottom portion 23 that constitutes the small-depth portion 5, as shown in FIG. 3B. In a region where the distal end of the bottom portion 23 is located at a position retracted (i.e., shifted to the right in FIG. 3B) from the position up to which the vertical wall portion 25 rises in the vertical direction, the second connecting portion 72 is formed with an inclined surface (slope) that connects the lower-level upper end of the vertical wall portion 25 with the distal end of the bottom portion 23 located at the retracted position. Namely, the second connecting portion 72 is shaped so as to connect the vertical wall portion 25 of the large-depth portion 6 with the bottom portion 23 of the small-depth portion 5, at a position lower than that of the first connecting portion 71.

Next, oil storage conditions of the oil pan 1 according to this embodiment of the invention will be described. In the following description, an oil storage condition observed when the automobile runs on a flat road, and an oil storage condition observed when the automobile runs on a downhill will be explained.

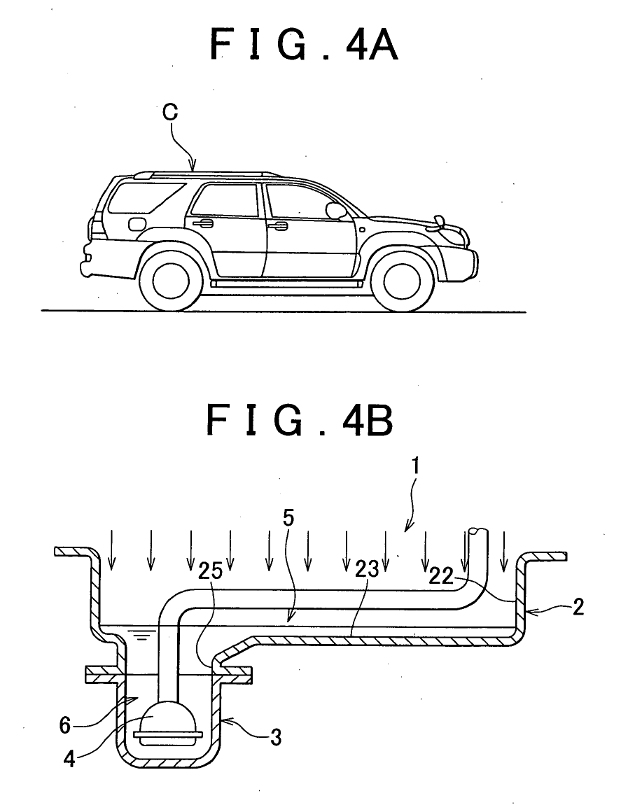

When an automobile C runs on a flat road, as shown in FIG. 4A, the oil pan 1 is not inclined, and a large portion of the oil in the oil pan 1 is stored in the large-depth portion 6 constituted by the vertical wall portion 25 of the upper oil pan 2 and the lower oil pan 3, as shown in FIG. 4B. In this condition, the oil that has been used for lubrication and cooling of various parts of the engine is substantially evenly collected into the lower oil pan 3 and the upper oil pan 2 (as indicated by arrows in FIG. 4B). Also, the oil collected into the small-depth portion 5 constituted by the wall portion 22 and bottom portion 23 of the upper oil pan 2 flows quickly into the lower oil pan 3, so that a sufficiently high oil level is surely established in the large-depth portion 6. Consequently, an oil inlet of the oil strainer 4 is prevented from being exposed to the air, namely, the oil pump is not brought into the “air sucking condition” as described above.

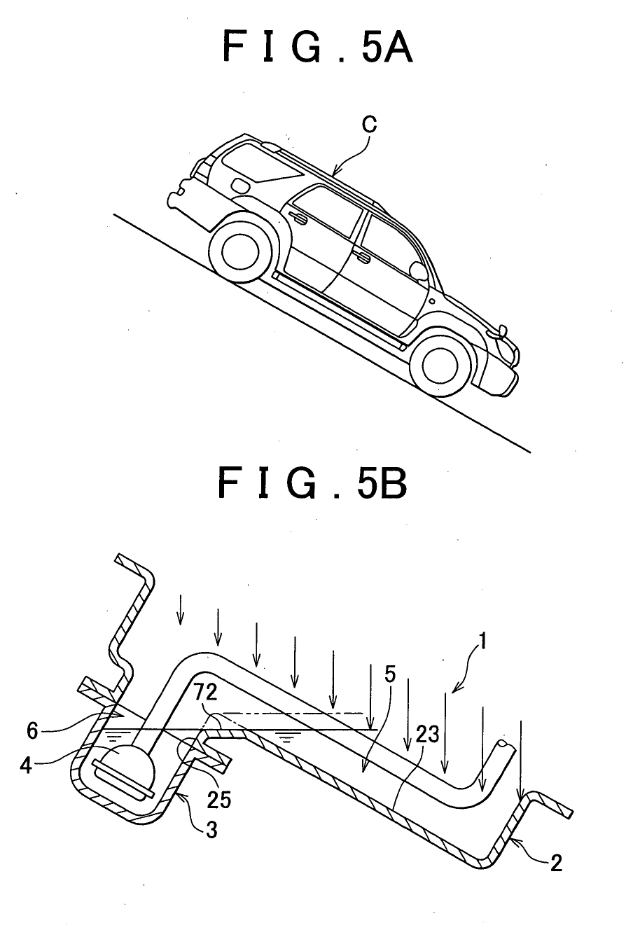

When the automobile C runs on a downhill, as shown in FIG. 5A, the oil pan 1 is inclined as shown in FIG. 5B, and a large portion of the oil that has been used for lubrication and cooling of various parts of the engine is collected, due to its own weight, toward the bottom portion 23 of the upper oil pan 2. Namely, a large portion of the oil is collected into the small-depth portion 5 of the oil pan 1 (as indicated by arrows in FIG. 5B, in which the length of the arrow represents the amount of oil collected in each region). This is because the oil flows down, under its own weight, along the inner walls of the cylinder block and the outer surface of the crankshaft, toward the front side of the vehicle body.

In this embodiment, a part of the ridge portion 7 between the small-depth portion 5 and the large-depth portion 6 is formed as the second connecting portion 72 that connects the vertical wall portion 25 of the large-depth portion 6 with the bottom portion 23 of the small-depth portion 5 at a relatively low level. In the above-described situation as shown in FIG. 5A and FIG. 5B, therefore, the oil level in the small-depth portion 5 becomes higher than the second connecting portion 72 even in a condition where the oil level in the small-depth portion 5 is relatively low, namely, even when the amount of oil collected into the small-depth portion 5 is relatively small, so that the oil starts flowing into the large-depth portion 6 over the second connecting portion 72.

In FIG. 5B, the solid line indicates an oil level which the oil in the small-depth region 5 reaches when the oil starts flowing from the small-depth portion 5 into the large-depth portion 6 in this embodiment. On the other hand, the virtual line (two-dot chain line) in FIG. 5B indicates an oil level which the oil in a small-depth region reaches when the oil starts flowing from the small-depth portion into a large-depth portion in an oil pan of the related art. As is understood from a comparison between these lines, in (the oil pan 1 of) this embodiment, the second connecting portion 72 allows the oil to flow from the small-depth portion 5 into the large-depth portion 6, even in a condition where the oil level in the small-depth portion 5 is relatively low. In FIG. 5B, the one-dot chain line indicates the shape or profile of the ridge portion of the oil pan according to the related art.

Thus, in this embodiment, even when the oil pan is in an inclined state, a sufficiently high oil level is surely established in the large-depth portion 6, and the “air sucking condition” in which the oil inlet of the oil strainer 4 is exposed to the air is avoided. Namely, it is possible to effectively avoid the “air sucking condition” as described above merely by changing the shape or configuration of the oil pan 1. While the lubricating oil may fail to be introduced into the oil pump and the operation to circulate the oil may not be smoothly carried out if the “air sucking condition” occurs, this situation can be avoided in this embodiment. Also, since various sliding parts in a pumping mechanism of the oil pump are held in well-lubricated conditions, wear of the components that constitute the oil pump is prevented, and good sealing is provided at sealed regions, thus assuring high reliability of the oil pump.

Since the above-described effects are provided only by improving the shape of the oil pan 1, as described above, the freedom or flexibility in design of the oil pan is not reduced under influences of other components that would otherwise be incorporated into the oil pan. Furthermore, the first connecting portion 71 and the second connecting portion 72 are formed as integral parts on the oil pan 1, thus making it possible to provide the oil pan 1 with high practicality, without increasing the number of components of the oil pan 1 or complicating the process of assembling the components into the oil pan 1.

The second connecting portion 72 is provided only in a part of the ridge portion 7 between the small-depth portion 5 and the large-depth portion 6, and the remaining part of the ridge portion 7, i.e., the first connecting portion 71, formed with a curved surface having a suitable radius of curvature connects the large-depth portion 5 with the small-depth portion 6 at a relatively high level (i.e., at a position higher than that at which the second connecting portion 72 connects the large-depth portion with the small-depth portion 6). Therefore, when the oil pan 1 is not in an inclined state, flowing of the oil from the large-depth portion 6 into the small-depth portion 5 is effectively restricted or inhibited at a location where the first connecting portion 71 is formed, and the first connecting portion 71 contributes to establishment of a sufficiently high oil level in the large-depth portion 6.

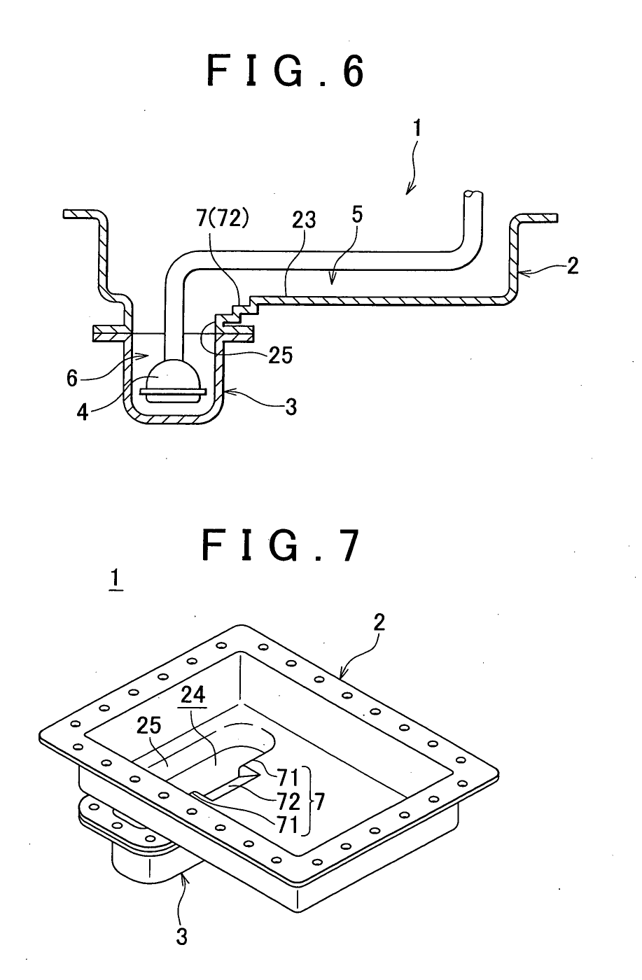

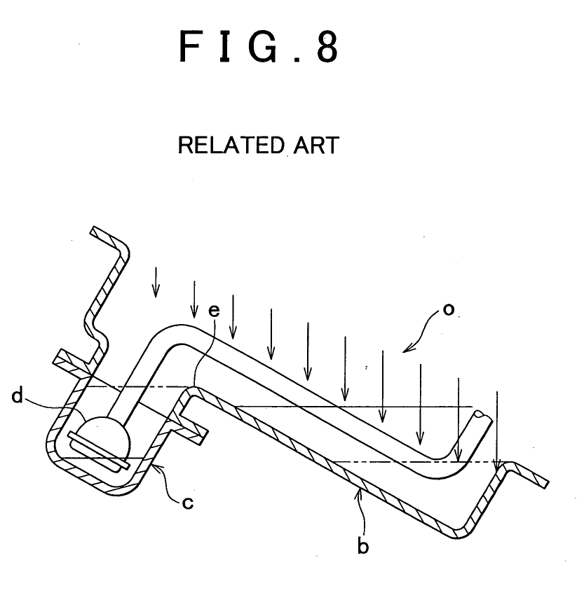

In the illustrated embodiment, the second connecting portion 72 is formed with the inclined surface (or slope). As a modified example of the embodiment, the second connecting portion 72 may be formed with a stepped portion shaped like stairs as shown in FIG. 6 (a cross-sectional view corresponding to that of FIG. 3B), in place of the inclined surface.

In this case, too, the second connecting portion 72 that connects the vertical wall portion 25 of the large-depth portion 6 with the bottom portion 23 of the small-depth portion 5 at a relatively low level is formed in a part of the ridge portion 7 between the small-depth portion 5 and the large-depth portion 6, so that effects similar to those of the illustrated embodiment are provided.

In the illustrate embodiment, the second connecting portion 72 is formed in one longitudinal end portion of the ridge portion 7. As another modified example of the illustrated embodiment, the second connecting portion 72 may be formed in a longitudinally middle portion of the ridge portion 7 as shown in FIG. 7 (a view corresponding to that of FIG. 1), and first connecting portions 71, 71 may be formed on the opposite sides of the second connecting portion 72.

While the second connecting portion 72 shown in FIG. 7 is formed with an inclined surface (or slope) as in the illustrated embodiment, the second connecting portion 72 may be formed as a stepped portion shaped like stairs as in the above-described modified example.

In the illustrated embodiment and its modified examples, the invention is applied to the oil pan 1 provided in the engine installed on the SUV. It is, however, to be understood that the present invention is not limited to this application, but may be applied to oil pans provided in engines installed on other types of vehicles. Also, the engine on which the oil pan according to the invention is installed is not particularly limited, but the invention may be applied to oil pans installed on various types of engines, such as gasoline engines and diesel engines, or engines having various cylinder arrangements, such as in-line engines, V-type engines and horizontal opposed engines, with no regard to the number of cylinders.

While the oil pan 1 is of a split type consisting of the upper oil pan 2 and the lower oil pan 3 in the illustrated embodiment and its modified examples, the invention may be equally applied to an oil pan in which the small-depth portion 5 and the large-depth portion 6 are formed as an integral body.

In the illustrated embodiment and its modified examples, the invention is applied to the oil pan 1 in which the lower oil pan 3 is provided in a rear portion of the bottom portion 23 of the upper oil pan 2 as viewed in the longitudinal direction of the vehicle. However, the invention is not limited to this arrangement, but may be applied to an oil pan in which the lower oil pan 3 is provided in a front portion of the bottom of the upper oil pan 2 as viewed in the longitudinal direction of the vehicle. In this case, when the vehicle runs on an uphill, the oil in the small-depth portion 5 is collected into the large-depth portion 6 via the second connecting portion 72, so as to provide the effect of the invention, namely, to ensure a sufficiently high oil level in the large-depth portion 6.

While the invention has been described with reference. to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. A structure for an oil pan that is provided in a lower part of an internal combustion engine, comprising:
a small-depth portion having a bottom that is positioned at a high level;
a large-depth portion formed adjacent to the small-depth portion and having a bottom that is positioned at a lower level than that of the small-depth portion, said large-depth portion defining an interior space in which an oil suction member is housed; and
a ridge portion that connects a vertical wall that forms the large-depth portion with a bottom wall that forms the small-depth portion,
wherein the ridge portion includes a first connecting portion that connects the vertical wall of the large-depth portion with the bottom wall of the small-depth portion via a curved surface, and a second connecting portion that connects the vertical wall of the large-depth portion with the bottom wall of the small-depth portion at a position lower than that of the first connecting portion.

2. The oil pan structure according to claim 1, wherein the second connecting portion is provided in one end portion of the ridge portion as viewed in a longitudinal direction thereof.

3. The oil pan structure according to claim 1, wherein the second connecting portion is provided in a middle portion of the ridge portion as viewed in a longitudinal direction thereof.

4. The oil pan structure according to claim 1, wherein the second connecting portion is formed with an inclined surface that connects the vertical wall of the large-depth portion with the bottom wall of the small-depth portion.

5. The oil pan structure according to claim 1, wherein the second connecting portion is formed with a stepped portion in the form of stairs, which connects the vertical wall of the large-depth portion with the bottom wall of the small-depth portion.

6. A structure for an oil pan that is provided in a lower part of an internal combustion engine, comprising:
a small-depth portion having a bottom that is positioned at a high level;
a large-depth portion formed adjacent to the small-depth portion and having a bottom that is positioned at a lower level than that of the small-depth portion, said large-depth portion defining an interior space in which an oil suction member is housed; and
a ridge portion that connects a vertical wall that forms the large-depth portion with a bottom wall that forms the small-depth portion,
wherein the ridge portion includes a first connecting portion and a second connecting portion;
the first connecting portion connects an upper end of the vertical wall of the large-depth portion continuously with a distal end of the bottom wall of the small-depth portion, in a region in which the upper end of the vertical wall of the large-depth portion has a vertical position that is substantially equal to that of the bottom wall of the small-depth portion, and the distal end of the bottom wall of the small-depth portion lies at a position up to which the vertical wall of the large-depth portion rises; and
the second connecting portion connects the upper end of the vertical wall of the large-depth portion with the distal end of the bottom wall of the small-depth portion at a position lower than the first connecting portion, in a region in which the upper end of the vertical wall of the large-depth portion has a vertical position that is lower than that of the bottom wall of the small-depth portion, and the distal end of the bottom wall of the small-depth portion lies at a position that is retracted from a position up to which the vertical wall of the large-depth portion rises.

7. The oil pan structure according to claim 6, wherein the second connecting portion is provided in one end portion of the ridge portion as viewed in a longitudinal direction thereof.

8. The oil pan structure according to claim 6, wherein the second connecting portion is provided in a middle portion of the ridge portion as viewed in a longitudinal direction thereof.

9. The oil pan structure according to claim 6, wherein the second connecting portion is formed with an inclined surface that connects the vertical wall of the large-depth portion with the bottom wall of the small-depth portion.

10. The oil pan structure according to claim 6, wherein the second connecting portion is formed with a stepped portion in the form of stairs, which connects the vertical wall of the large-depth portion with the bottom wall of the small-depth portion.

11. An internal combustion engine comprising an oil pan having the oil pan structure as defined in claim 1.

12. The internal combustion engine according to claim 11, wherein, when the internal combustion engine is installed on a vehicle, the large-depth portion of the oil pan is provided in a rear portion of the bottom wall of the small-depth portion as viewed in a longitudinal direction of the vehicle.

13. The internal combustion engine according to claim 11, wherein, when the internal combustion engine is installed on a vehicle, the large-depth portion of the oil pan is provided in a front portion of the bottom wall of the small-depth portion as viewed in a longitudinal direction of the vehicle.

14. An internal combustion engine comprising an oil pan having the oil pan structure as defined in claim 6.

15. The internal combustion engine according to claim 14, wherein, when the internal combustion engine is installed on a vehicle, the large-depth portion of the oil pan is provided in a rear portion of the bottom wall of the small-depth portion as viewed in a longitudinal direction of the vehicle.

16. The internal combustion engine according to claim 14, wherein, when the internal combustion engine is installed on a vehicle, the large-depth portion of the oil pan is provided in a front portion of the bottom wall of the small-depth portion as viewed in a longitudinal direction of the vehicle.
